(19) United States
(12) Patent Application Publication
(10) Pub. No.: US 2023/0349582 A1
(43) Pub. Date: Nov. 2, 2023

(54) PERSONAL COMFORT VARIABLE AIR VOLUME DIFFUSER WITH IMPROVED AIR QUALITY ELEMENTS

(71) Applicant: Trane International Inc., Davidson, NC (US)

(72) Inventors: Deep Gupta, La Crosse, WI (US); Kaustubh Pradeep Phalak, La Crosse, WI (US); Gang Wang, Holmen, WI (US); Scott A. Munns, Onalaska, WI (US); Chandrashekhar S. Nadgouda, Karnataka (IN)

(21) Appl. No.: 18/340,721

(22) Filed: Jun. 23, 2023

Related U.S. Application Data
(63) Continuation of application No. 17/308,664, filed on May 5, 2021.

(51) Int. Cl. F24F 11/79; F24F 8/22; F24F 11/58; F24F 11/00; F24F 13/14

(52) U.S. Cl. CPC F24F 11/79; F24F 8/22; F24F 11/0001; F24F 11/58; F24F 13/1426; F24F 2120/10

(57) ABSTRACT

Disclosed are techniques relating to an improved air quality device that can provide personalized comfort and improved air quality elements to occupants of a common space. The improved air quality device can comprise a plurality of individually adjustable directional outlets. The state of these individually adjustable directional outlets can be updated to individually satisfy comfort levels of various occupants at different locations within the common space, which can be determined based on inputs from a control device (e.g., thermostat), a sensor (e.g., occupancy sensor), and so forth. The improved air quality device can further comprise an ultraviolet light device that can reduce pathogens in the common space. The state of the ultraviolet light device (e.g., on/off, duration of on/off, a position/location, and so on) can be a function of the state of the state of the outlets.

### BACKGROUND

### 1. Technical Field

The present disclosure relates generally to heating, ventilation, and air conditioning (HVAC) systems, and in particular, to a variable air volume diffuser comprising a configurable ultraviolet light device that improves the quality of personalized air delivered to occupants of a climate-controlled space.

### 2. Background of Related Art

In HVAC systems, conditioned air is delivered to a building space by a variable air volume (VAV) diffuser. The VAV diffuser is often ceiling-mounted and includes a damper that regulates the flow of air passing through the diffuser, and outlet vents through which the conditioned air exits the diffuser into the space. The outlet vents typically include a grille or a series of louvers that direct the conditioned air into the space. In some systems, ducts are commonly used to connect a VAV box to the diffusers and/or outlet vents.

Indoor air quality is a burgeoning concern for HVAC uses in multiple environments, including hospital, clinical, industrial, educational, food distribution, retail, indoor agriculture, government, military, and others. The COVID-19 pandemic has highlighted the need for clean air, not just with reduced pathogen risk, but with mitigations for particulate matter (PM), CO₂, volatile organic compounds (VOCs), and so forth.

Known diffusers may have drawbacks in that they deliver conditioned air to the building space in a manner intended to satisfy the requirements of the space as a whole, without considering air quality or the requirements of individual occupants of the space. A VAV diffuser that optimizes air quality and safety along with personalized occupant comfort in a user-friendly, cost-effective and energy-efficient manner would be a welcome advance in the art.

### SUMMARY

In one aspect, the present disclosure is directed to a heating, ventilation, and air conditioning (HVAC) device. The HVAC device can comprise a plurality of adjustable directional outlets. The plurality of adjustable directional outlets can be respectively configured to discharge air into a common space. The HVAC device can further comprise an ultraviolet light device. The ultraviolet light device can be configured to reduce pathogens in the common space. The HVAC device can further include a processor and a memory that stores executable instructions that, when executed by the processor, facilitate performance of certain operations. The processor can thus control operation of the plurality of adjustable directional outlets and the ultraviolet light device. For example, the operations performed by the processor can comprise updating a state of the plurality of individually adjustable directional outlets in accordance with a first control signal. The operations can further comprise updating a state of the ultraviolet light device in accordance with a second control signal.

In some embodiments, the processor can be remote from the HVAC device such as, for example, situated in a control unit or device. In some embodiments, the first control signal (e.g., the signal that controls the plurality of individually adjustable directional outlets) can be determined independently of the second control signal (e.g., the signal that controls the ultraviolet light device).

In some embodiments, the first control signal can be determined based on the same or different inputs as the second control signal. For example, an occupancy signal that indicates the common space is occupied can trigger air flow through one of the plurality of individually adjustable directional outlets and might also trigger deactivation of the ultraviolet light device.

In some embodiments, a state of the ultraviolet light device can be a function of a state of the plurality of individually adjustable directional outlets. In some embodiments, elements described in connection with the systems or apparatuses above can be embodied in different forms such as a method of fabricating they system or apparatus, or another suitable form.

Other features and advantages will become apparent from the following description of the preferred embodiments, taken in conjunction with the accompanying drawings.

### BRIEF DESCRIPTION OF THE DRAWINGS

Various embodiments of the disclosed system and method are described herein with reference to the drawings wherein:

FIG. 1 illustrates a conditioned space incorporating a personalized comfort V A V system in accordance with an embodiment of the present disclosure;

FIG. 2 is a detailed view of a personalized comfort VAV diffuser in accordance with an embodiment of the present disclosure;

FIG. 3 is a schematic view of a personalized comfort VAV controller in accordance with an embodiment of the present disclosure;

FIGS. 4A-4B illustrate an embodiment of a remote device user interface of a personalized comfort VAV system in accordance with the present disclosure;

FIGS. 5A-5C are perspective views of an embodiment of a personalized comfort VAV controller in accordance with the present disclosure;

FIG. 6 is a flowchart illustrating a method of operating a personalized comfort V A V diffuser in accordance with an embodiment of the present disclosure;

FIG. 7 illustrates a diagram of first example non-limiting air quality device with an ultraviolet light device situated at a bottom portion in accordance with one or more embodiments of the disclosed subject matter;

FIG. 8 illustrates a second example air quality device with an ultraviolet light device at an upper portion in accordance with one or more embodiments of the disclosed subject matter;

FIG. 9 illustrates a third example air quality device in accordance with one or more embodiments of the disclosed subject matter;

FIG. 10 illustrates a block diagram of a system that can provide for fine control of one or more air quality devices in accordance with one or more embodiments of the disclosed subject matter;

FIG. 11 illustrates a fourth example air quality device that can facilitate airstream cleaning techniques in accordance with one or more embodiments of the disclosed subject matter;

FIGS. 12A-C illustrate numerous additional examples relating to the air stream cleaning techniques in accordance with one or more embodiments of the disclosed subject matter;

FIGS. 13A and 13B illustrate a fifth example air quality device that can facilitate dry hydrogen peroxide (DHP) techniques and/or photo catalytic oxidization (PCO) techniques in order to reduce pathogens in accordance with one or more embodiments of the disclosed subject matter;

FIGS. 14A-C illustrate numerous additional design examples relating to the DHP and/or PCO techniques in accordance with one or more embodiments of the disclosed subject matter;

FIG. 15 illustrates still another design examples relating to the DHP and/or PCO techniques in accordance with one or more embodiments of the disclosed subject matter;

FIG. 16 illustrates a flow diagram of an example, non-limiting method for controlling an air quality device in accordance with one or more embodiments of the disclosed subject matter; and

FIG. 17 illustrates a flow diagram of an example, non-limiting method that can provide additional aspects or elements in connection with controlling an air quality device in accordance with one or more embodiments of the disclosed subject matter; and

FIG. 18 illustrates a block diagram of an example, non-limiting operating environment in which one or more embodiments described herein can be facilitated.

The various aspects of the present disclosure mentioned above are described in further detail with reference to the aforementioned figures and the following detailed description of exemplary embodiments.

### DETAILED DESCRIPTION

Particular illustrative embodiments of the present disclosure are described hereinbelow with reference to the accompanying drawings, however, the disclosed embodiments are merely examples of the disclosure, which may be embodied in various forms. Well-known functions or constructions and repetitive matter are not described in detail to avoid obscuring the present disclosure in unnecessary or redundant detail. Therefore, specific structural and functional details disclosed herein are not to be interpreted as limiting, but as a basis for the claims and examples for teaching one skilled in the art to variously employ the present disclosure in any appropriately-detailed structure. In this description, as well as in the drawings, like-referenced numbers represent elements which may perform the same, similar, or equivalent functions. The word “exemplary” is used herein to mean “serving as a non-limiting example, instance, or illustration.” Any embodiment described herein as “exemplary” is not necessarily to be construed as preferred or advantageous over other embodiments. The word “example” may be used interchangeably with the term “exemplary.”

Aspects of the present disclosure are described herein in terms of functional block components and various processing steps. It should be appreciated that such functional blocks configured to perform the specified functions may be embodied in mechanical devices, electromechanical devices, analog circuitry, digital circuitry, and/or modules embodied in a computer. For example, the present disclosure may employ various discrete components, integrated circuit components (e.g., memory elements, processing elements, logic elements, look-up tables, and the like) which may carry out a variety of functions, whether independently, in cooperation with one or more other components, and/or under the control of one or more processors or other control devices. One skilled in the art will also appreciate that, for security reasons, any element of the present disclosure may include any of various suitable security features, such as firewalls, access codes, authentication, encryption, de-encryption, compression, decompression, and/or the like. It should be understood that the steps recited herein may be executed in any order and are not limited to the order presented. Moreover, two or more steps or actions recited herein may be performed concurrently.

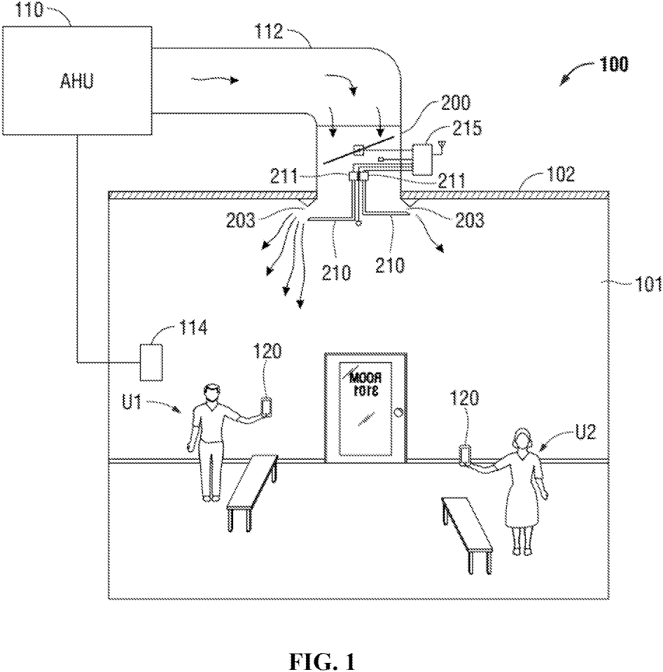

FIG. 1 illustrates an exemplary embodiment of a personalized comfort VAV system 100 in accordance with the present disclosure. VAV system 100 is installed in conditioned space 101 which can be, for example, an office, workroom, conference room, manufacturing floor of a factory, or any space where two or more people may gather. Conditioned air is delivered to conditioned space 101 by personalized comfort VAV diffuser 200 that, typically, is mounted through ceiling 102 of conditioned space 101. V A V diffuser 200 receives conditioned air from an air handler unit 110 via an air duct 112. A temperature sensor 114 is operatively coupled to air handler unit 110 to control the delivery of conditioned air into conditioned space 101 to maintain a desired temperature setpoint therein. It is appreciated that other sensors may be used such as a humidity sensor, air quality sensor, and so forth. Temperature sensor 114 may, for example, be included in a thermostat, or may be a standalone sensor. While FIG. 1 shows a single air handler 110 feeding a single VAV diffuser 200 associated with a single space 101, it should be understood that the present disclosure contemplates any suitable configuration of air handler units 110, personalized comfort VAV diffusers 200 and conditioned spaces 101, such as, for example, an air handler unit 110 that feeds a plurality of personalized comfort VAV diffusers 200 and/or a conditioned space that includes a plurality of personalized comfort VAV diffusers 200. Hence, it should be appreciated that one or more embodiments of the disclosed subject matter can include a plurality of AHUs 110 supplying a plurality of personalized comfort VAV diffusers 200.

V A V diffuser 200 includes a plurality of adjustable air guides 210 that are arranged to direct airflow from VAV diffuser 200 in a specific direction. While in the various example embodiments discussed here, VAV diffuser 200 is shown to have two or four adjustable air guides 210, the present disclosure is not so limited and it should be understood that VAV diffuser 200 may include any number of adjustable air guides 210. V A V diffuser 200 includes controller 215 that in one aspect is configured for wireless communication with one or more user devices 120 to provide personalized air delivery to individual users of the user devices 120, e.g., user U1 and user U2. User device 120 may include, for example, a smart phone, tablet computer, notebook computer, a dedicated handheld or fixed keypad (remote control), and so forth.

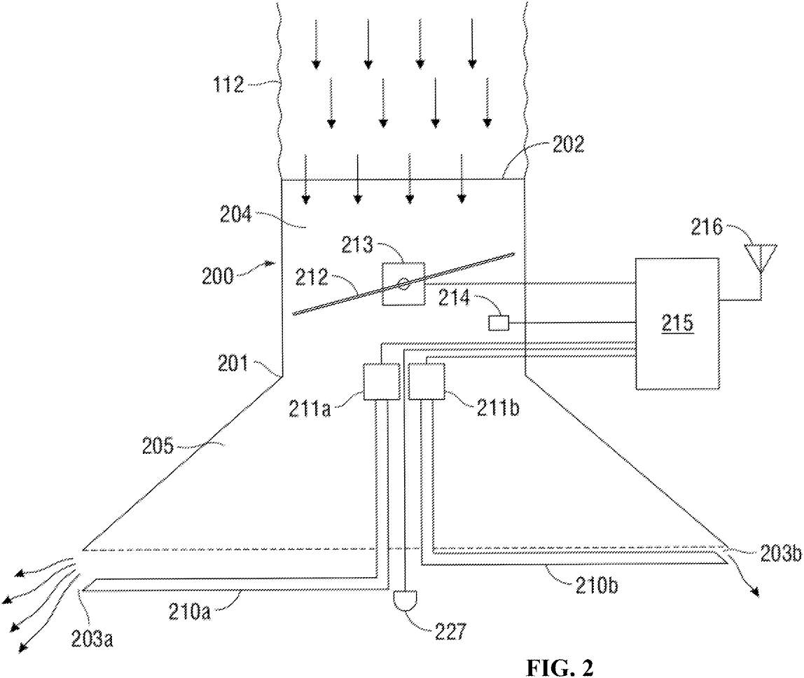

In more detail, FIG. 2 illustrates an exemplary construction of VAV diffuser 200. V A V diffuser 200 includes a housing 201 having an inlet 202 through which conditioned air enters an inlet plenum 204. A motorized damper 212 actuated by stepper motor 213 controls the flow of conditioned air from inlet plenum 204 to outlet plenum 205. A sensor 214 can sense a property of the conditioned air within outlet plenum 205, such as air pressure. It is appreciated that in some embodiments, a flow ring can be attached to an inlet plenum (not shown). In embodiments, sensor 214 may additionally or alternatively sense the air temperature, air velocity, air humidity, and/or noise level within outlet plenum 205. Each adjustable air guide 210 is operatively associated with a corresponding stepper motor 211 that is configured to adjust the position of adjustable air guide 210 to control the amount of conditioned air flowing from air outlet 203. In the example embodiment depicted in FIG. 2, stepper motors 211a and 211b are arranged to lower and raise adjustable air guides 210a and 210b, respectively, to increase or decrease the size of respective air outlets 203a and 203b and increase or decrease the volume of air flowing through air outlets 203a and 203b, respectively. Alternatively, damper 212 and/or any of adjustable air guides 210 may be actuated by, for example, a servo motor, pneumatic actuator, wax motor, and so forth. In some embodiments, airflow characteristics can be measured using a flow ring, which can eliminate use of damper 212 for some applications.

Occupancy sensor 227 senses when one or more persons are present within conditioned space 101 and may include, for example, a passive infrared (PIR) motion detector, a video camera configured to sense motion or objects, an RF signal detector configured to detect the presence of RF emissions from a user mobile device, an acoustic detector configured to sense the sounds of human activity, and so on. In some embodiments having a microphone 224 as described below, the function of occupancy sensor 227 may be performed by microphone 224. It is appreciated that one or more sensors detailed herein can be situated on or near VAV diffuser 200 or might be situated elsewhere such as at a local thermostat or control device.

V A V diffuser 200 includes controller 215 that is in operative communication with stepper motor 213 to control the position of damper 212; with stepper motors 211a, 211b etc. to control the position of respective adjustable air guides 210a, 210b etc., with with sensor 214 to receive a property of conditioned air within outlet plenum 205, and with occupancy sensor 227 to detect when conditioned space 101 is occupied. Controller 215 is configured for operative communication with one or more user devices 120 to transmit identification information thereto and receive personal comfort settings therefrom. In the present embodiment, controller 215 communicates with the one or more user devices 120 a wireless communications link via antenna 216. In embodiments, controller 215 may additionally or alternatively communicate with the one or more user devices 120 via a wired communications link. In embodiments, controller 215 includes an optical receiver (phototransistor) to communicate with a user device via an infrared communications link. In some embodiments, controller 215 includes audio input and output capability (e.g., a microphone and speaker) to communicate directly with a user via audio prompts and voice recognition of spoken user commands.

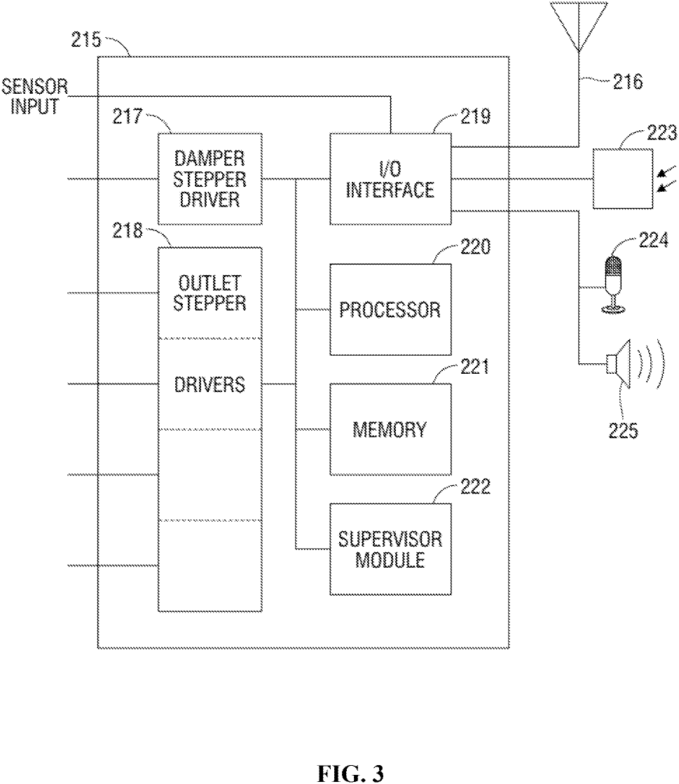

FIG. 3 is a more detailed view of an embodiment of controller 215. Controller 215 includes a processor 220 operatively coupled with a memory 221. Memory 221 may include volatile and non-volatile memory, such as RAM, ROM, EEPROM, flash memory, optical, or magnetic disk memory, in any desired form factor, such as dual inline package (DIP), surface mount device (SMD), SD card, USB stick, hard drive, solid state drive (SSD) and so forth. An input/output (I/O) interface 219 is operatively coupled to processor 220 to support communications with sensor 214, occupancy sensor 227, and other devices as described herein. In one embodiment, I/O interface 219 includes antenna 216 and supports a wireless networking protocol based on the IEEE 802.15.4 low power wireless standard to implement a near-me area network (NAN) to enable mobile devices 120 in proximity with VAV diffuser 200 to communicate with VAV diffuser 200. Other embodiments may optionally or alternatively implement other wireless communications protocols, such as Bluetooth, IEEE 802.11 (WiFi), and so forth.

In another embodiment, IO interface 219 is operatively coupled to a photoreceptor 223, such as an infrared (IR) phototransistor, to receive communications from an IR emitter included in a handheld remote control device or in an IR peripheral suitable for use with a mobile device 120. In yet another embodiment, I/O interface 219 is operatively coupled to a microphone 224 and speaker 225 to enable VAV diffuser 200 to respond to spoken commands and issue voice prompts to enable direct communications with a user without the need for the user to be in possession of a mobile device.

Controller 215 includes stepper driver 217 that includes circuitry for driving damper stepper motor 213, and stepper driver 218 that includes circuitry for driving the one or more air guide stepper motors 211. In embodiments where alternative actuators are employed, e.g., servo motor, pneumatic actuator, wax motor, etc., the appropriate driving circuitry is utilized.

Controller 215 includes supervisor module 222 that is configured to receive personal comfort settings, e.g., an adjustable air guide 210 setting, from a user; to adjust the position of adjustable air guide 210 in accordance with the received user-specified setting; to receive from sensor 214 a property of the conditioned air within outlet plenum 205 (e.g., the air pressure); and to adjust the position of damper 212 in response to the sensed property. Supervisor module 222 may be embodied as any suitable software and/or hardware as will be appreciated by those having skill in the art and/or as described herein.

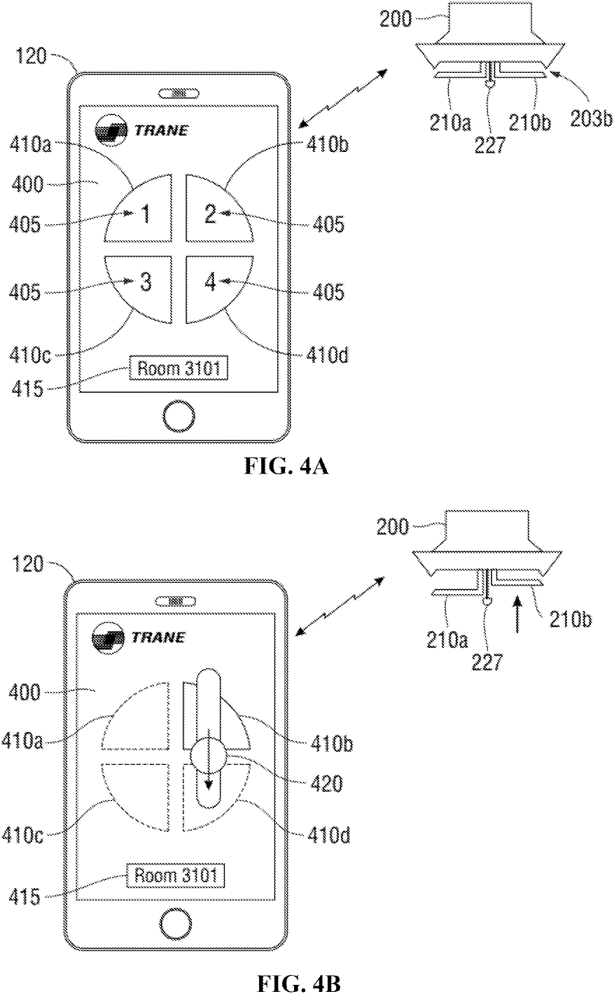

Referring to FIGS. 1, 4A, and 5A, during use each adjustable air guide 210 of V A V diffuser 200 may initially be adjusted to a middle position, e.g., at approximately 50% open (FIG. 4A). V A V diffuser 200 delivers cooled air into conditioned space 101 which, in the present example, is identified as Room 3101 and which is occupied by two persons, user U1 who is comfortable with the environmental conditions in the room, and user U2 who is feeling uncomfortably cold. Since each adjustable air guide 210 is adjusted to the same middle position, the volume of air flowing in each direction is substantially equal.

To enhance user U2′s comfort, he or she utilizes the present invention to reduce the volume of air flowing in his or her direction by adjusting the appropriate adjustable air guide 210, e.g., the air guide(s) facing most towards user U2. To accomplish this, user U2 utilizes his or her user device 120 to establish an operative connection with VAV diffuser 200. As shown in FIGS. 4A and 4B, a user interface 400 is presented on user device 120 which includes a visual representation 410a, 410b, etc. of each adjustable air guide 210a, 210b, etc. of VAV diffuser 200. An application program (“app”), a web app (e.g., a javascript program executing within a browser application), or other suitable software architecture may be employed to present user interface 400 to the user.

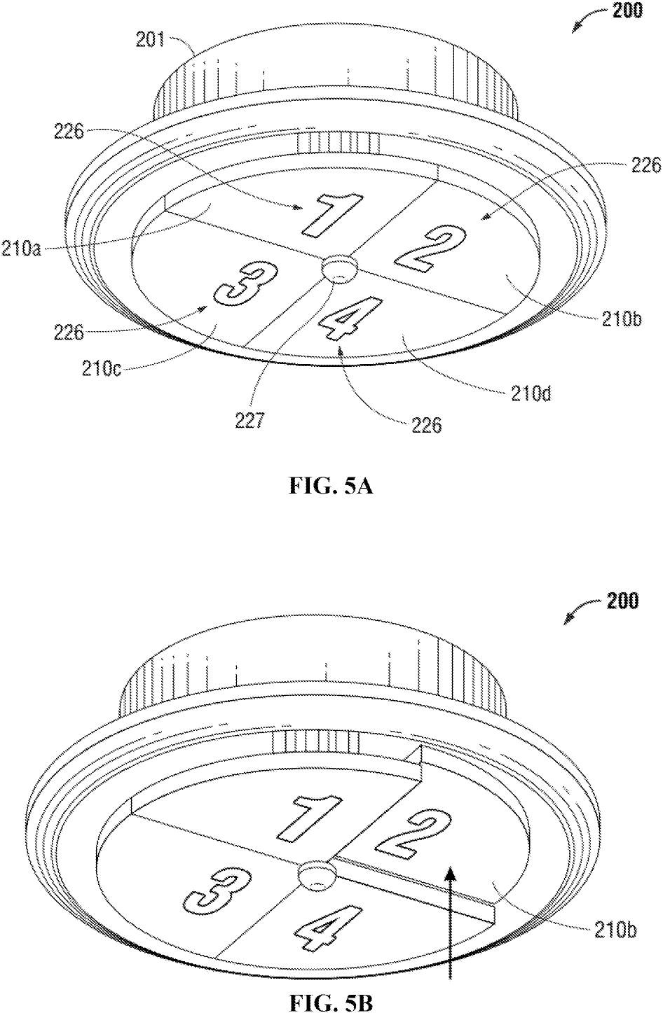

To enable the user to identify the appropriate adjustable air guide 210 for adjustment, each visual representation 410a, 410b, etc. includes an identifying indicia 405 which corresponds to a matching indicia 226 disposed on a surface of each adjustable air guide 210a, 210b, etc. As seen in FIGS. 5A-5C, indicia 226 can be a numeral (e.g., the numerals 1 through 4) however it is contemplated that a letter, icon, picture, words, color, or any other visually distinctive feature may serve as indicia to identify adjustable air guides 210. In certain situations, for example, to comply with government regulations, indicia 226 may include features perceptible to persons with sensory impairments, such as Braille labels, acoustic cues, illumination, and so forth.

In some embodiments, VAV diffuser 200 transmits an identifier 415 to user device 120 to enable the user to confirm user device 120 is in communication with the intended VAV diffuser 200. This is useful when, for example, more than one VAV diffuser 200 is present in a single conditioned space 101, or where a communications link with a VAV diffuser in a nearby room may be inadvertently established. In these instances, each available VAV diffuser 200 is listed in a drop down list, a rolling picker, or other suitable user interface element from which the user may select the desired VAV diffuser 200. In some embodiments, user device 120 displays only the VAV diffuser 200 that is physically nearest to user device 120 based on signal strength, signal propagation time, or other suitable criteria. In some embodiments, user device 120 displays VAV diffusers 200 sorted in proximity order, for example, nearest to farthest.

Once the desired adjustable air guide 210 is identified, the user selects, on the user interface, the visual representation of the adjustable air guide 210 to activate a control widget 420, which enables the user to adjust the position of the selected adjustable air guide 210. In the present example, user U2 has activated visual representation 410b to select adjustable air guide “B” (210b). As seen in FIG. 4B, control widget 420 can be a slider. As control widget 420 is manipulated downward to decrease air volume, an adjustment command is communicated from user device 120 to supervisor module 222, adjustable air guide 210b moves upward, reducing the size of air outlet 203b and thus decreasing the air flowing towards user U2 to increase user U2′s comfort.

Those skilled in the art will recognize that a user that is uncomfortably warm can utilize the disclosed invention in the opposite manner, i.e., to increase the flow of air directed at the user. Similarly, when air handler unit 110 is delivering heated air to conditioned space 101, a user may advantageously employ the disclosed invention to adjust heat delivery as desired. It is noted that some VAV equipment can produce heat independently of an associated AHU, which can be taken into account.

Reducing the size of air outlet 203b to reduce airflow from that air outlet results in a pressure increase within outlet plenum 205 that causes increased airflow from the other air outlets 203a, 203c, etc. Conversely, when the size of an air outlet is increased, the resultant decreased pressure within outlet plenum 205 causes decreased airflow from the other outlets. Such changes to the airflow directed toward other occupants may affect or impair the comfort of these other occupants. Additionally, outlet noise may increase as a result of increased pressure within outlet plenum 205.

To obviate these undesirable effects, air pressure within outlet plenum 205 is sensed by sensor 214, which communicates a pressure signal to supervisor module 222 of controller 215. In an embodiment, supervisor module 222 records the pressure within outlet plenum 205 prior to an air outlet adjustment. If a pressure change is sensed within outlet plenum 205, for instance, after an adjustment to an adjustable air guide 210, supervisor module 222 causes a corrective adjustment to be made to damper 212 to cancel the pressure change cause by the adjustment of the air guide 210, e.g., to adjust the pressure within outlet plenum 205 to substantially equal to its prior state. Substantially equal may include equal to, or within a predetermined tolerance of, the pre-adjustment pressure. For example, substantially equal can include a post-adjustment pressure that is within 5% of the pre-adjustment pressure. In another example, substantially equal can include a post-adjustment pressure that is within 15% of the pre-adjustment pressure. In an embodiment, supervisor module 222 communicates an adjustment signal to damper stepper driver 217, which, in turn, actuates stepper motor 213 to open or close damper 212 as required to effectuate the appropriate pressure adjustment within outlet plenum 205. In an embodiment, supervisor module 222 employs a proportional integral derivative feedback loop (PID) to regulate pressure within outlet plenum 205, which can be in accordance with flow or pressure measurements detailed herein.

In this manner, the disclosed personalized comfort VAV system 100 enables occupants of a conditioned space to enjoy personalized comfort without affecting the comfort of other occupants of the conditioned space.

FIGS. 5A-5C illustrate an exemplary embodiment of VAV diffuser 200 in various operational states. FIG. 5A depicts VAV diffuser 200 where each adjustable air guide 210a-d is in a medium or default position. FIG. 5B depicts VAV diffuser 200 where adjustable air guide 210b is in a raised (low flow) position and FIG. 5C depicts V A V diffuser 200 where adjustable air guide 210b is in a lowered (high flow) position.

In an embodiment, sensor 214 is configured to sense whether air is flowing though V A V diffuser 200. In an embodiment, supervisor module 222 is configured to ignore an adjustment command received from a user device 110 in the event no airflow is detected. In an embodiment, supervisor module 222 is configured to return adjustable air guides 210 to a preset default position (e.g., a medium position) in the event no airflow has been detected for a predetermined period of time, for example, 30 minutes. In an embodiment, supervisor module 222 is configured to return damper 212 to preset default position (e.g., a full or a medium position) in the event no airflow has been detected for a predetermined period of time (e.g., 30 minutes).

In an embodiment, supervisor module 222 is configured to return adjustable air guides 210 to a preset default position (e.g., a medium position) in the event no occupancy of conditioned space 101 has been detected for a predetermined period of time, for example, 30 minutes. In an embodiment, supervisor module 222 is configured to return damper 212 to preset default position (e.g., a full or a medium position) in the event no occupancy of conditioned space 101 has been detected for a predetermined period of time (e.g., 30 minutes).

In an embodiment, supervisor module 222 may be programmed for provisioning of default positions (of adjustable air guides 210 and/or damper 212) by an installer. In an embodiment, supervisor module 222 may be programmed with a VAV diffuser 200 identifier by an installer.

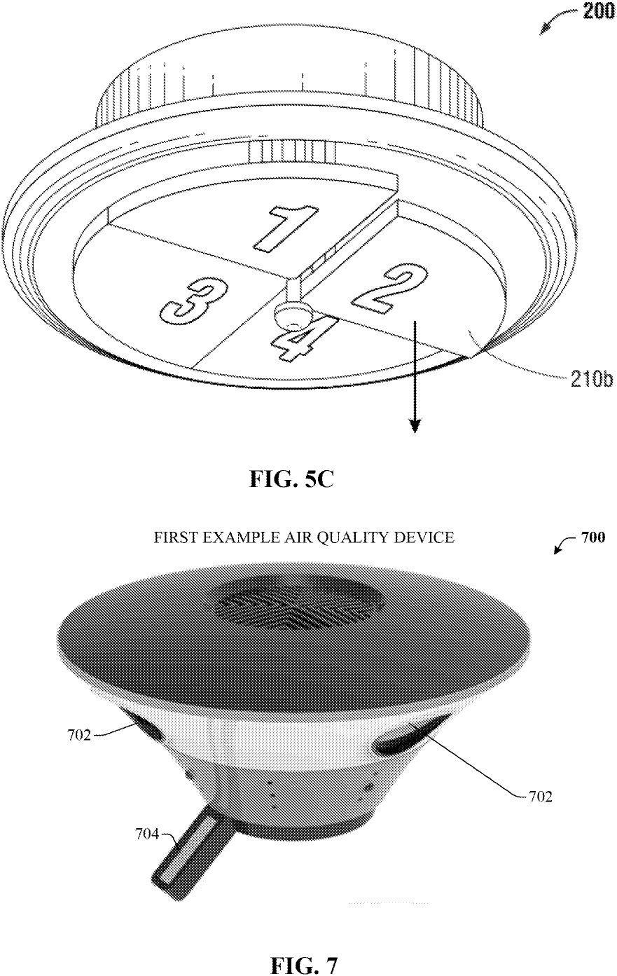

FIG. 6 is a flowchart of a method 600 of operating a personalized comfort V A V diffuser in accordance with an embodiment of the present disclosure. The method 600 begins with step 605 wherein communication is established between the VAV diffuser and the user. In step 610, a VAV diffuser identifier is communicated to the user, who in step 615 selects a desired VAV diffuser for personalized adjustment. In step 620 the VAV diffuser receives a request to adjust an air guide thereof. In step 625, a pre-adjustment pressure of an outlet plenum of the VAV diffuser is measured, and in step 630, the requested air guide adjustment is performed. In step 635, a post-adjustment pressure of the outlet plenum of the VAV diffuser is measured, whereupon in step 640 the pressure of the outlet plenum is adjusted to substantially equal the pre-adjustment pressure. In step 645, the position of the air guide(s) and the outlet plenum pressure adjustment is reset to default values if no activity is detected for more than a predetermined period of time, such as no air flow through the VAV and/or no occupancy is detected in proximity to the VAV diffuser for a predetermined period of time.

### Personal Comfort Device with Improved Air Quality Elements

The personal comfort devices and techniques detailed above in connection with FIGS. 1-6 can be further enhanced with the addition of improved air quality elements, which is further detailed hereinafter. Indoor air quality is a burgeoning concern for HVAC customers in many domains, such as hospitals and clinics, manufacturing and industrial, schools, food distribution, retail, indoor agriculture, government, and many others. The recent COVID-19 pandemic has highlighted a need for improved air quality. In addition to pathogen risk, there is also heightened concern about many other air quality metrics such as particulate matter (PM), carbon dioxide (CO2), volatile organic compounds (VOCs) and so forth.

However, the benefits of air quality mitigation are often difficult to measure, and can pressure the value proposition. For example, if building occupants do not know about air quality measures, or cannot tell if they are being actively managed, a system does little to improve their confidence in that regard, which can reduce the value that can be extracted from such measures. Compounding this issue, regular use of fresh air ventilation or other mitigations may increase the energy consumption of a given HVAC solution, resulting in higher costs and potentially higher CO2 emissions impact. To address these and other issues, the disclosed subject matter is broadly concerned with improving or optimizing air quality, environmental comfort, and energy efficiency. As illustrated above, seeking to improve or optimize any one of these three goals can sometimes conflict with or be orthogonal to that of the others. For instance, the use of fresh air, which can improve air quality, tends to reduce comfort or tends to increase costs or decrease efficiency.

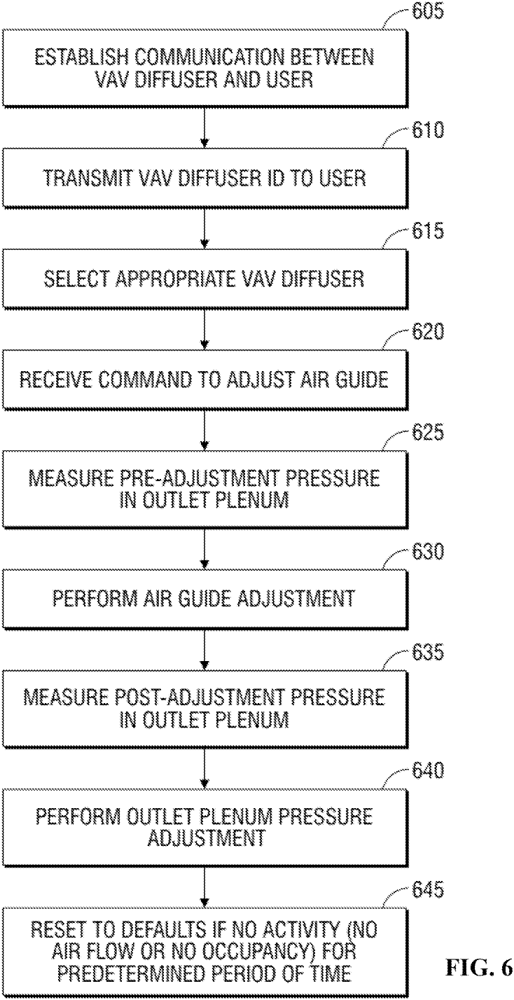

The personal comfort devices detailed previously focused extensively on two of the above-noted goals, namely energy efficiency and personal comfort. The disclosed personal comfort device (or similar devices) can be further enhanced by adding improved air quality elements such as an ultraviolet light device, a dry hydrogen peroxide (DHP) device, a photo catalytic oxidation (PCO) device, or the like, which is illustrated beginning with FIG. 7. These additions can serve to improve or optimize air quality while maintaining the energy efficiency of the personal comfort devices. In accordance with the disclosed subject matter, in some cases, personal comfort and peace of mind as well as energy efficiency can be still further improved along with the addition of improved air quality.

With reference now to FIG. 7, a diagram of first example non-limiting air quality device 700 is illustrated with an ultraviolet light device situated at a bottom portion in accordance with one or more embodiments of the disclosed subject matter. Although different designs are depicted, air quality devices detailed herein, including example air quality device 700, can include any suitable aspect, element or technique of person comfort devices detailed above, such as personalized comfort VAV diffuser 200. Like personalized comfort VAV diffuser 200, air quality device 700 can comprise a plurality of individually adjustable directional outlets, indicated as outlets 702. Outlets 702 can be respectively configured to discharge air into a common space.

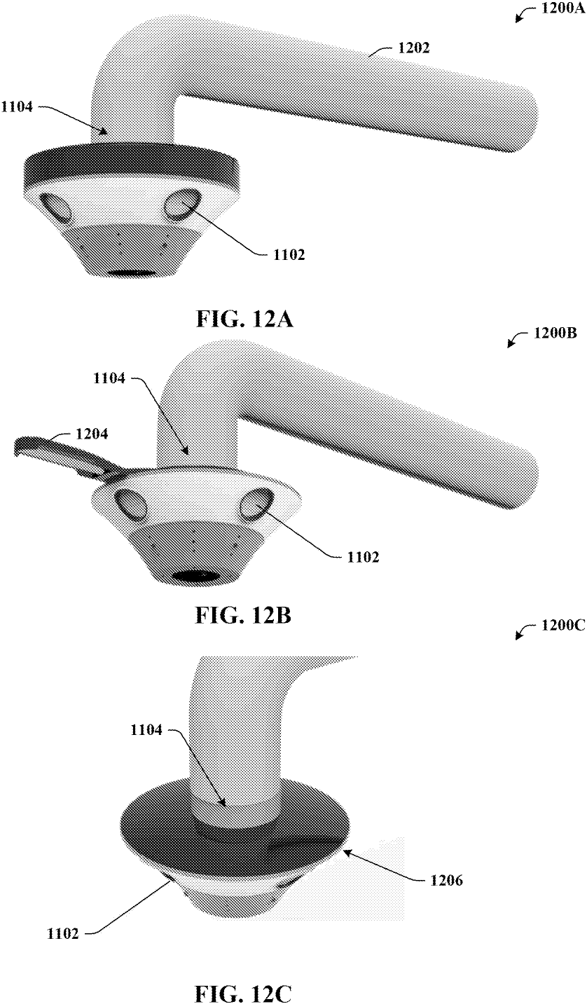

In some embodiments, the air discharged can be from a common plenum, which can be served by a supply duct (not shown, but see air duct 112 of FIG. 1 or duct 1202 of FIG. 12-A-C) at either the top or bottom of the device, depending on the implementation. For example, an air quality device can be mounted in or suspended from the ceiling or be an upright configuration that receives supply air from below. In some embodiments, air can be drawn from the surrounding environment in cases where there is no supply duct, for example. Dampers or other devices (not shown, but see damper 212) can regulate the pressure or airflow within the common plenum as one or more of the individual outlets 702 change state.

Air quality device 700 can further comprise an ultraviolet light device 704. Ultraviolet light device 704 can be configured to expose air and surfaces within the common space to ultraviolet light, which can kill or reduce pathogens within the common space. As depicted, in some embodiments, ultraviolet light device 704 can be coupled to a housing for the plurality of individually adjustable directional outlets 702 and/or to the common plenum.

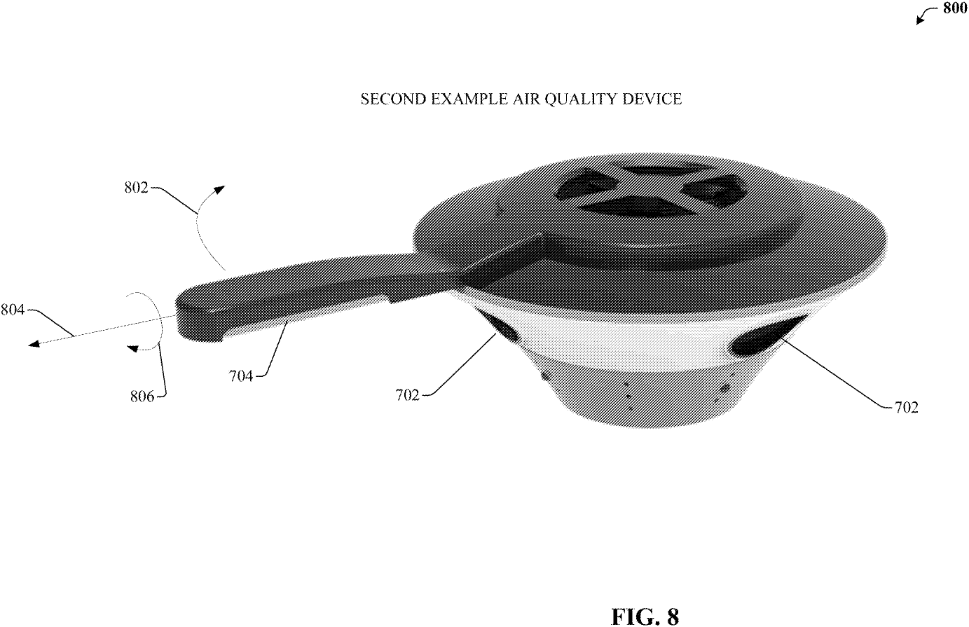

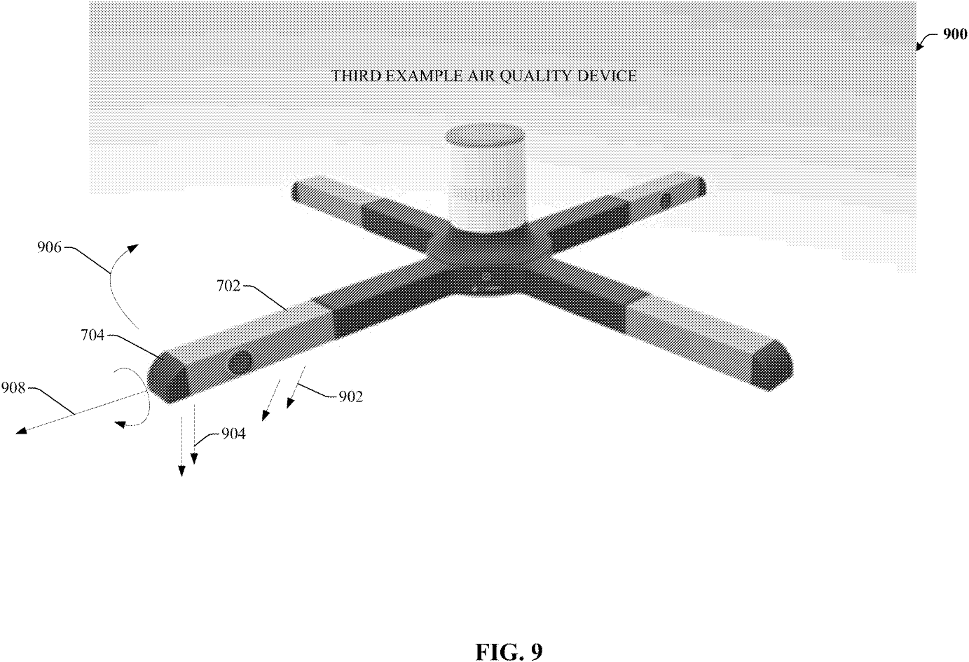

FIG. 8 illustrates a second example air quality device 800 with an ultraviolet light device at an upper portion in accordance with the disclosed subject matter and FIG. 9 illustrates a third example air quality device 900 in accordance with the disclosed subject matter. While ultraviolet light device 704 is configured to shine light upward in connection with air quality device 700, the configuration of air quality device 800 is suitable for shining light downward. Air quality device 900 illustrates a different design concept where directional lines 902 indicate an example of the direction of air flow from one of the outlets 702 and dashed directional lines 904 indicate an example of the general direction of light emanating from one of the ultraviolet light devices 704.

Still referring to FIGS. 7-9, it is apparent from these examples that ultraviolet light device 704 can be configured for locomotion and such can be controlled according to the disclosed techniques. In some embodiments, ultraviolet light device 704 can rotate about or orbit the housing (e.g., see motion indicators 802 and 906) such that various regions of the common space can be targeted. In some embodiments, ultraviolet light device 704 can pivot about a lateral axis (e.g., see lateral axes 804 and 908) such that air and surfaces above, below, or to the side of ultraviolet light device 704 can be targeted.

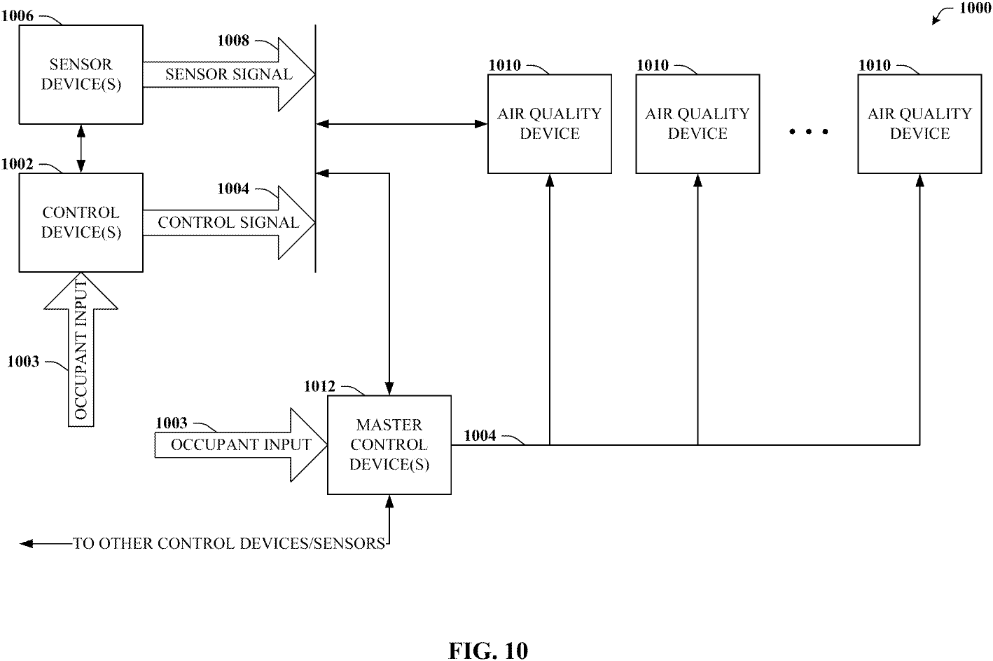

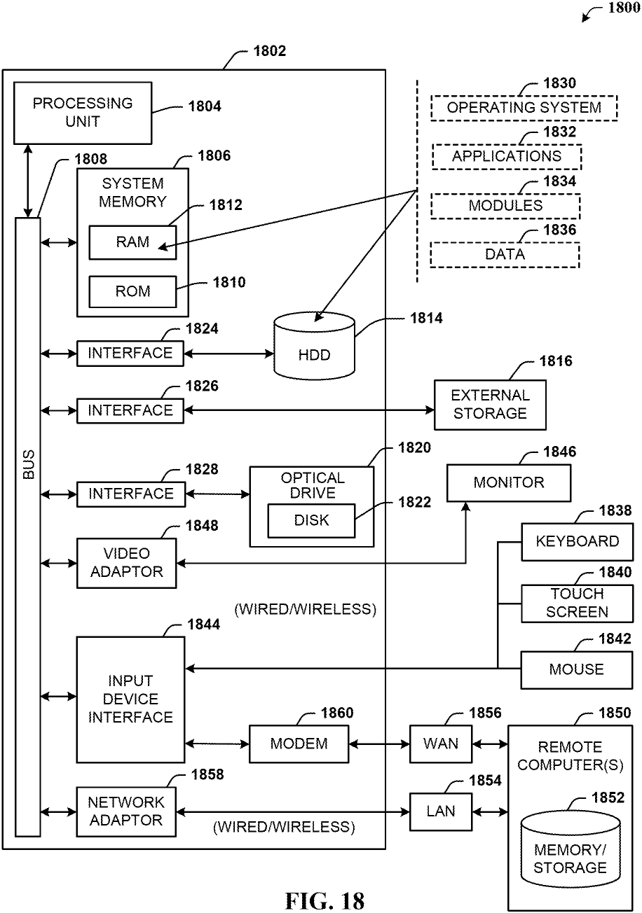

Position and/or orientation control of ultraviolet light device 704 can be controlled by one or more actuators or by another suitable means. In some embodiments, air quality devices 700, 800, 900 or others can include a processor or other computing components such that all or a portion of determinations regarding the states of outlets 702 (e.g., comfort settings) and the states of ultraviolet light device 704 (e.g., air quality settings) can be performed by (e.g., on-board) air quality devices 700, 800, 900 or others. In other embodiments, all or a portion of those determinations can be performed by a master control device or unit, which is further detailed in connection with FIG. 10. Examples of said processor as well as other suitable computer or computing-based elements, can be found with reference to FIG. 18, and can be used in connection with implementing one or more of the devices or components shown and described in connection with figures disclosed herein.

Turning now to FIG. 10, a block diagram of system 1000 with is depicted. System 100 can provide for fine control of one or more air quality devices in accordance with one or more embodiments of the disclosed subject matter. Control of air quality device 1010 can be effectuated based on control signal 1004. Control signal 1004 can control, the state of outlets 702 and the state of ultraviolet light device 704. Control signal 1004 can be output from a control device 1002 or master control device 1012 based on any suitable input such as, sensor signal 1008 that can be received from one or more sensor device(s) 1006.

By way of example, control device 1002 can be a thermostat that controls the environment of the common space or an individualized portion of the common space served by one of the outlets 702. As another example, control device 1002 may be an application being executed on a mobile device or other computing device, such as a computer or phone of a potential occupant of the common space.

In some embodiments, control device 1002 can be integrated into air quality device 1010. In some embodiments, control device 1002 can control a single air quality device (e.g., states of outlets 702 and ultraviolet light device 704), whereas master control device 1012 (e.g., a building automation system (BAS) device) can control multiple air quality devices 1010.

In any case, control signal 1004 can be determined based on occupant input 1003, which can be representative of input to an application, thermostat, BAS, or other control element. Occupant input 1003 can be a set point or other environmental metric and may also include personal information relating to occupants such as preferences or current states of well-being. For instance, occupant input 1003 can be in response to a welcome message that inquires how one feels today. If the occupant input 1003 indicates the occupant does not feel especially well, such can be used to affect the behavior of air quality device 1010. It is appreciated that occupant input can be provided by occupants or other suitable or authorized parties such as a building manager or the like.

In addition to occupant input 1003, control signal 1004 can further be determined based on output from one or more sensor device 1006. As a representative example, sensor device 1006 can be an occupancy sensor that can sense whether the common space or a portion thereof is occupied as well as a count of occupants in the space. It is appreciated that numerous other sensors can be employed, such as environmental sensors (e.g., temperature, humidity, and so on) that can determine ambient environmental conditions, fish-eye lens cameras or other cameras that can determine visual parameters, infrared devices that can determine body temperatures of occupants, or other suitable sensors.

Outputs from all or a portion of sensor devices 1006 can be employed to determine control signal 1004, which can be utilized to set or update states for air quality device 1010. In other words, control device 1002 and/or master control device 1012 can determine a personal comfort setting based on the various inputs. In response, control signal 1004 can be issued to update a state of outlets 702 of one or more air quality devices 1010 in order to effectuate the personal comfort setting. Also in response to the various inputs, control signal 1004 can be issued to update a state of ultraviolet light device 704 of one or more air quality devices 1010 in order to effectuate an air quality metric.

By way of example, an Indoor Air Quality (IAQ) index can be maintained. The IAQ index can, e.g., indicate a safety rating or metric for the indoor space. Thus, in some embodiments, elements of system 1000 can act as an IAQ monitoring device with a set of appropriate sensors (e.g., sensor device(s) 1006) monitoring various air quality parameters. Measurements from certain sensor device(s) 1006 can be compared with baseline safety limits prescribed by a determined IAQ standard or default. Reference values also can be updated based on health safety standards set for present or preferred conditions. For instance, if a certain infective organism has a higher infection rate in lower relative humidity conditions, the reference range for relative humidity can be narrowed to reduce the likelihood of infection spread as well as to meet minimum IAQ standards.

As another example, consider a scenario in which wild fires have occurred in at nearby locations. These wild fires can produce particulate matter (PM) that is a higher in concentration than otherwise. In response, the PM levels can be updated for such events.

Based on the sensor measurements and the reference values mentioned, specific control / risk mitigation action, or a set of actions, can be taken by the HVAC or BAS system, such as by control device(s) 1002 and/or master control device(s) 1012. By way of illustration, such actions can include manual interventions like issuing warnings to replace or upgrade filter, direct control actions like OA damper control and so forth.

Based on the IAQ metrics, IAQ index will be calculated to determine overall health and safety conditions of indoor air. This IAQ index value will be reported on displays or personal communication devices like smart phones of the occupants.

It is appreciated that the state of ultraviolet light device 704 can be indicative of whether the lamp is on or off, a duration or frequency of on/off pulses, a position or trajectory/path of ultraviolet light device 704, an orientation of ultraviolet light device 704, an intensity or wavelength of the ultraviolet light, or another suitable parameter. In some embodiments, the state of ultraviolet light device 704 can be determined as a function of the state of outlets 702.

For example, consider an occupant arriving at a workstation. An occupancy sensor can identify the arrival and a personal comfort setting can update a state of one or more outlets 702 to effectuate a desired environmental condition for that particular occupant or at that particular workstation. Optionally, parameters for the entirety of the common space may be adjusted, for instance, to increase energy efficiency. Shortly thereafter, the occupant vacates the workstation and common space and the states of outlets 702 revert back to a previous or unoccupied setting. In response to outlets 702 reverting back to the unoccupied setting, ultraviolet light device 704 can be activated to, e.g., immediately clean the workspace after occupation. Such an action can be further based on sensor outputs, for instance, suppose an infrared sensor detected that the occupant had a fever or elevated body temperature.

As another example, consider the case in which an occupancy sensor or camera determines that a high number of people are currently occupying the common space or a particular portion of the common space. The comfort settings associated with outlets 702 can be updated to address this situation, and likewise, potentially as a function that update, ultraviolet light device 704 can be programmed or updated accordingly.

In some embodiments, ultraviolet light device 704 can be configured to produce ultraviolet light having a wavelength that is less than or equal to a human-safe threshold. A human-safe threshold can be one that has been determined to be safe for human exposure. As an example, the human-safe threshold can be ultraviolet light that has a wavelength of about 222 nanometers or less.

In some embodiments, ultraviolet light device 704 can be configured to expose a portion of the common space to ultraviolet light for a duration that is greater than or equal to a pathogen killing time. In some embodiments, the pathogen killing time is about 0.2 seconds.

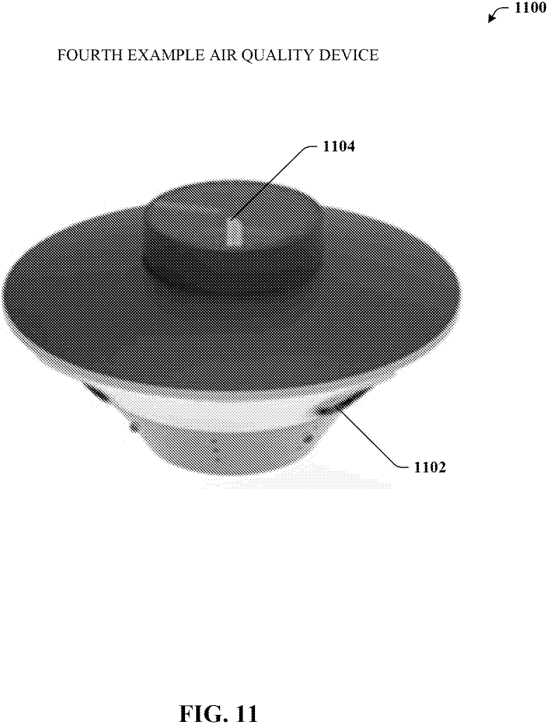

Referring now to FIG. 11, a diagram of a fourth example air quality device 1100 is depicted. Air quality device 1100 illustrates an airstream cleaning device in accordance with one or more embodiments of the disclosed subject matter. As with other examples, Air quality device 1100 can include a one or more outlets 1102, the states of which can be individually adjusted. In addition, air quality device 1100 can further include a second type of ultraviolet light device 1104. As illustrated, ultraviolet light device 1104 can have a smaller footprint than other examples (e.g., ultraviolet light device 704) and can be situated at an intersection with a duct (e.g., see duct 1202 of FIGS. 12A-C).

While still referring to FIG. 11, but turning as well to FIGS. 12A-C, numerous additional examples 1200A, 1200B, and 1200C are provided in accordance with one or more embodiments of the disclosed subject matter. Because ultraviolet device 1104 is situated inside the confines of duct 1202, the type of ultraviolet light used can be more intense, even beyond ranges that are deemed safe for human exposure. As one example, an 18 watt device can be employed that can generate broadband ultraviolet light having wavelengths in the range of 250-260 nanometers. Such a device can operate without production of ozone.

Portions of ultraviolet light device 1104 can extend into duct 1202 or internally within air quality device 1100, and can operate to kill or reduce certain pathogens and other agents deemed harmful or undesirable. It is appreciated that effects of ultraviolet light device 1104 can operate upon return air flows, supply air flows, or a combination thereof.

Furthermore, as specifically illustrated in connection with illustration 1200B, air quality device 1100 can be combined with ultraviolet light device 704 that can be situated on an exterior of the device to combat external pathogens while ultraviolet device 1104 combats pathogens in the return or supply airflows within duct 1202.

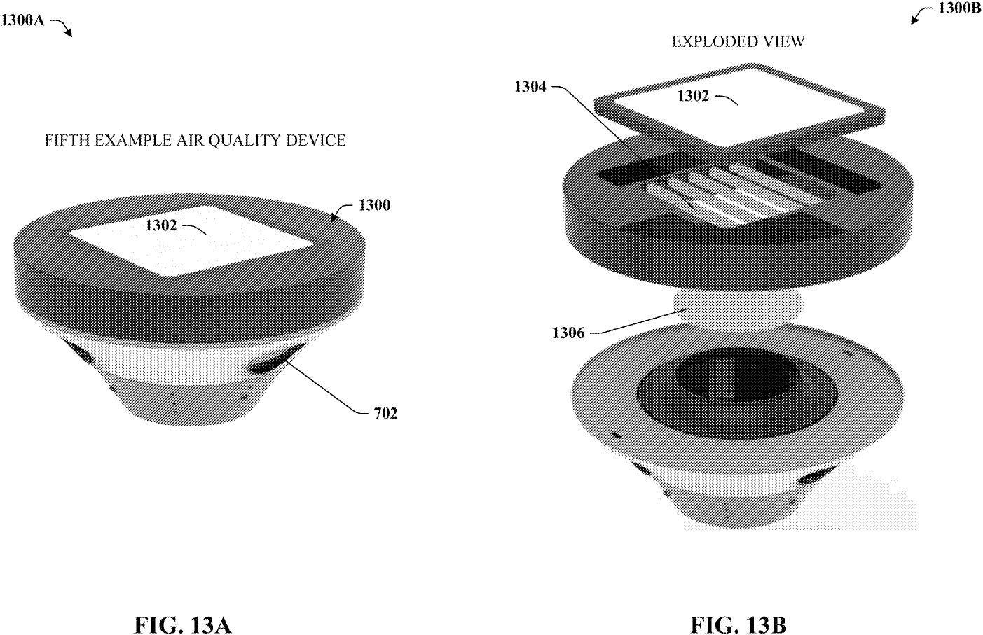

With reference now to FIGS. 13A and 13B, views 1300A and 1300B are depicted. View 1300A illustrates a fifth example air quality device 1300 comprising a dry hydrogen peroxide (DHP) device in accordance with one or more embodiments of the disclosed subject matter. View 1300B illustrates an exploded view of air quality device 1300 in accordance with one or more embodiments of the disclosed subject matter.

Air quality device 1300 can comprise outlets 702 as detailed herein. Additionally, air quality device 1300 can comprise filter 1302. Filter 1302 can operate to trap or remove small particles circulating through the common space. Examples particles can include dust, pollen, mold, and other irritants or agents deemed undesirable. In some embodiments, filter 1302 can be a minimum efficiency reporting value (MERV) rated ASHRAE (American Society of Heating, Refrigerating and Air-Conditioning Engineers) certified filter.

In some embodiments, as illustrated in view 1300B, air quality device 1300 can comprise ultraviolet light device(s) 1304. Ultraviolet light device 1304 can produce a range of ultraviolet light wavelengths determined to be sufficient to activate photocatalytic reactions of a humid ambient air environment. Such can produce purified hydrogen peroxide gas (PHPG) including hydrogen peroxide. Typically, such can be produced without photlyzing oxygen to initiate the formation of ozone.

Such can be accomplished in response to the ultraviolet light interacting with catalyst structure 1306. Catalyst structure 1306 can comprise a metal or metal oxide material. Examples can include titanium dioxide, copper, copper oxide, zinc, zinc oxide, or mixtures, alloys, or combinations thereof. The photocatalysts can generate hydroxyl radicals from absorbed water when activated by ultraviolet light of a sufficient energy that is generated by ultraviolet light device 1304. These hydroxyl radicals can then react with humid ambient air to produce the PHPG.

It is understood that DHP, as used herein, can represent a non-aqueous gas, which can be used for environmental disinfection. The biocidal activity of hydrogen peroxide in any form (e.g., liquid, vapor, dry gas, and so on) is rooted in the fact that microbes require water to survive and have electrostatically charged points on their cells designed to attract water molecules from the environment.

Hydrogen peroxide molecules are similar to water molecules and thus are also attracted to these charged points. However, unlike water molecules, hydrogen peroxide attacks microbes and disrupts their cell membrane. Because hydrogen peroxide will compete with water molecules for access to these points on a microbe’s cell wall, higher concentrations of hydrogen peroxide can be useful to disinfect when in the presence of water.

When DHP gas is catalytically produced from gases already extant in the air (e.g., from ambient oxygen and water in a humid environment), such can be safely used in occupied spaces to achieve microbial reduction at concentrations well below known human safety threshold such as those published by agencies such as Occupational Safety and Health Administration (OSHA).

Moreover, unlike aqueous forms of hydrogen peroxide, including vapors, that are acidic because of the chemical properties associated with mixing hydrogen peroxide and water, dry hydrogen peroxide gas does not damage common surfaces in an occupant space. Hence, the integrity of surfaces ranging from those of electronic monitoring devices to soft privacy curtains are not degraded or compromised.

Furthermore, as a gas, the DHP can permeate throughout a space, reaching and reducing microbial bioburden in remote, recessed areas within a room or other space. Thus, challenges associated with compliance, comprehensive microbial reduction, and disruption to patient throughput are reduced or eliminated. While the role of manual cleaning remains an important part, areas that receive infrequent cleaning will benefit by the continuous microbial reduction process afforded by DHP. Additionally, because continuous microbial reduction provided by DHP can reduce the steady state of environmental contaminations, standard intermittent adjunctive cleaning interventions address a much lower bioburden and is therefore more effective and/or more efficient.

In addition to, or alternatively to, techniques detailed above relating to production of DHP, other techniques relating to Photo Catalytic Oxidation (PCO) can be leveraged. PCO can operate to convert organic compounds to carbon dioxide and water in a manner similar to the production of DHP and/or PHPG detailed above. For instance, the composition of catalyst structure 1306 can comprise various catalyst material such as titanium dioxide and the wavelength of the ultraviolet light generated by ultraviolet light device(s) 1304 can be tuned to the particular solid catalyst material. For example, the wavelength of the ultraviolet light can be in a range of about 350-400 nanometers for titanium dioxide, but can be in a different range for different catalyst material.

It is believed that exposing the catalyst material (e.g., catalyst structure 1306) to the right wavelength of ultraviolet light can promote an electron to a conduction band of the catalyst structure. The promoted electron leaves a positively charged hole in the valence band. In the presence of water vapor (e.g., humid air) this positively charged hole operates as an oxidizing species and can oxidize hydroxide (OH⁻) from water vapor to form hydroxyl radicals (OH⁰). These hydroxyl radicals can be extremely reactive and can act as a nonselective oxidizer that repeatedly attacks most organics, converting them to carbon dioxide and water via free radical reactions.

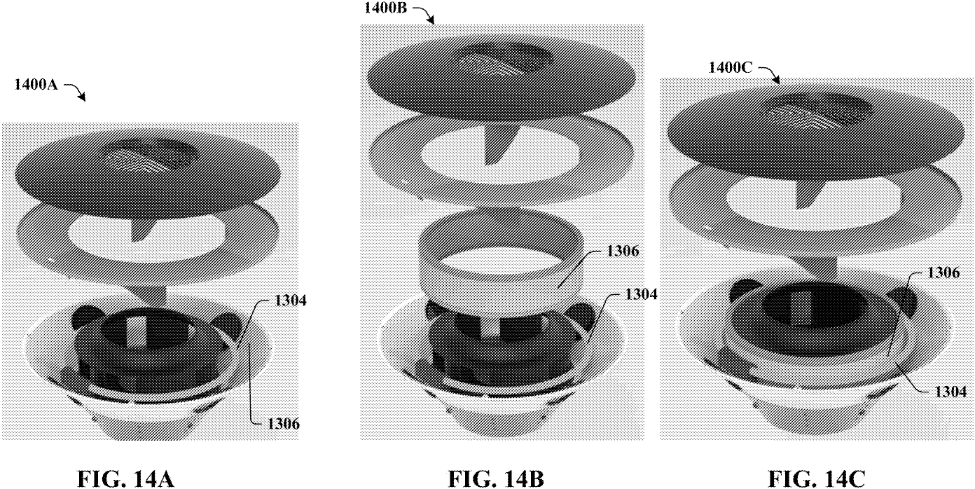

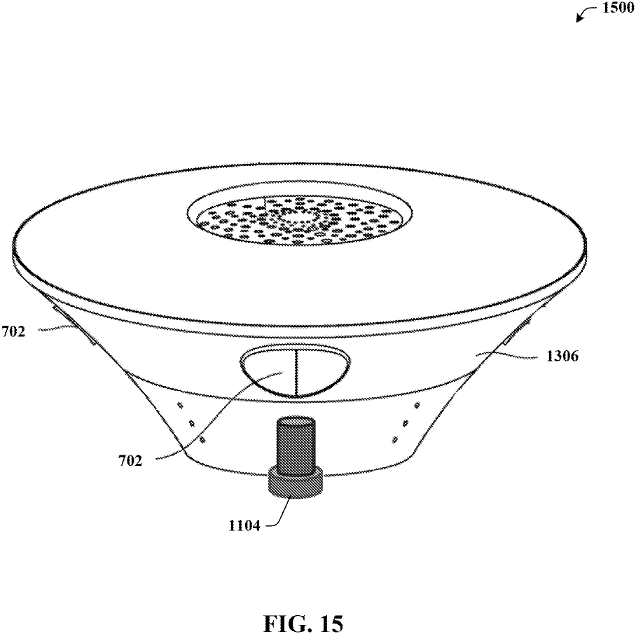

It is appreciated that the design illustrated in FIGS. 13A and 13B are non-limiting examples, and other designs are contemplated. For example, FIGS. 14A-C and FIG. 15 give additional design examples in connection with DHP and/or PCO techniques in accordance with one or more embodiments of the disclosed subject matter. In that regard, FIGS. 14A-C illustrate exploded views 1400A-1400C in which ultraviolet light device 1304 is shaped as a ring situated inside the air quality device housing. As illustrated by FIG. 14A, catalyst structure 1306 can be situated on an interior portion of the housing. Hence, ultraviolet light from ultraviolet light device 1304 that is emanating outward in a radial fashion can expose catalyst structure 1306 to facilitate one or more of the DHP or PCO techniques described above.

In examples provided by FIGS. 14B and 14C, catalyst structure 1306 can be situated inside the ring of ultraviolet light device 1304. Hence, ultraviolet light from ultraviolet light device 1304 that is emanating inward in a radial fashion can expose catalyst structure 1306 to facilitate one or more of the DHP or PCO techniques described above.

FIG. 15 illustrates air quality device 1500. Air quality device 1500 can comprise ultraviolet light device 1104 situated in the interior of the housing similar to that described in connection with FIG. 11. Catalyst structure 1306 can be situated on interior walls of the housing as described in connection with FIGS. 14A-C.

### Example Methods

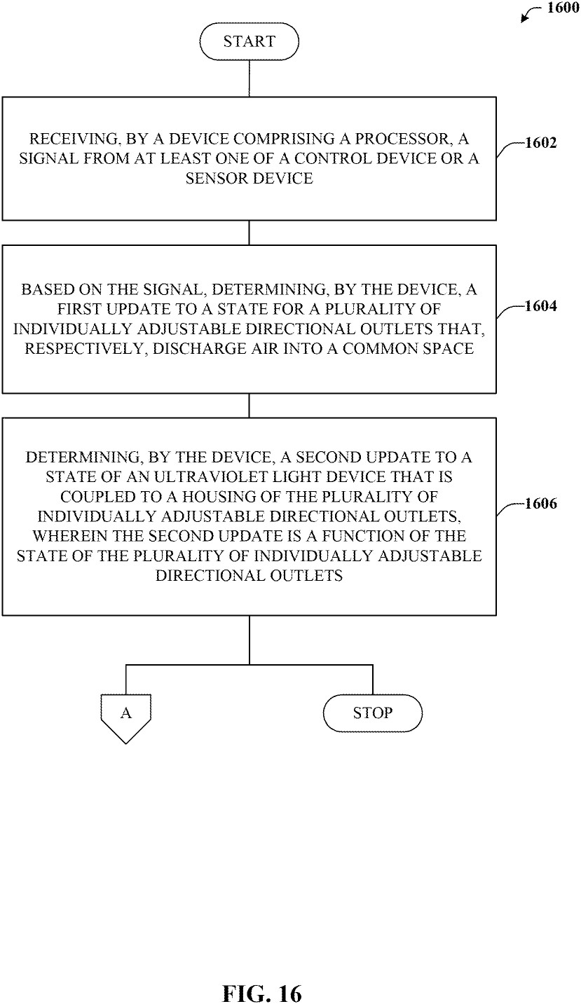

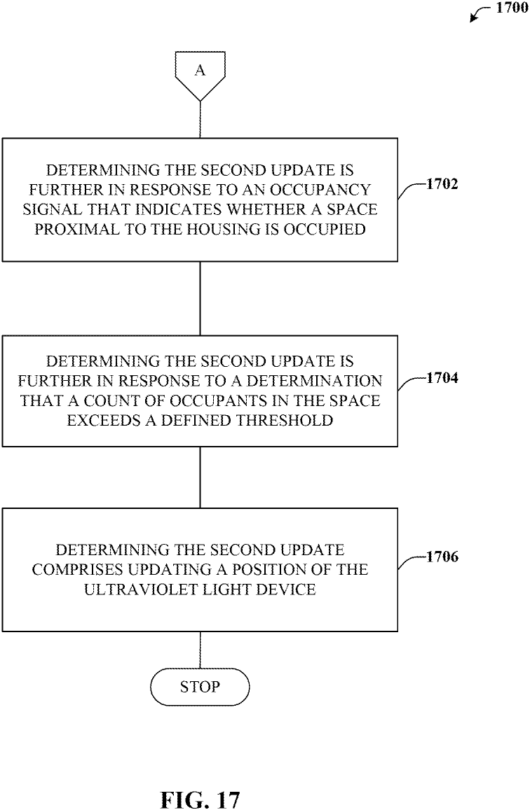

FIGS. 16 and 17 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts can occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers.

FIG. 16 illustrates a flow diagram 1600 of an example, non-limiting method for controlling an air quality device in accordance with one or more embodiments of the disclosed subject matter. For example, at reference numeral 1602, a device comprising a processor can receive a signal from at least one of a control device or a sensor device. Examples of said processor as well as other suitable computer or computing-based elements, can be found with reference to FIG. 18, and can be used in connection with implementing one or more of the devices or components shown and described in connection with figures disclosed herein. The device comprising the processor can facilitate control of one or all of personal comfort, energy efficiency, and air quality in regard to controlled air quality device such as air quality devices 700, 800, 900, 1010, 1100, 1200A-C, 1300, 1400A-C, or 1500.

At reference numeral 1604, based on the signal, the device can determine a first update to a state of the air quality device. For instance, the first update can represent an update to one or more of a plurality of individually adjustable directional outlets of the air quality device that, respectively, discharge air into a common space.

At reference numeral 1606, the device can determine a second update to a state of the air quality device. For instance, the second update can be an update to a state of an ultraviolet light device t′hat is coupled to a housing of the plurality of individually adjustable directional outlets. For example, in DHP embodiments, the second update can determine that DHP is to be supplied to the common space and, in response, activate the appropriate type of ultraviolet light device (e.g., ultraviolet light device 1304). Advantageously, in some embodiments, the second update can be a function of the first update and/or a function of the state of the plurality of individually adjustable directional outlets. Such can enable efficient and robust integration of satisfying individualized comfort, energy efficiency, and excellent air quality. Method 1600 can proceed to insert A, which is further detailed in connection with FIG. 17, or terminate.

Turning now to FIG. 17, illustrated is a flow diagram 1700 of an example, non-limiting method that can provide additional aspects or elements in connection with controlling an air quality device in accordance with one or more embodiments of the disclosed subject matter.

At reference numeral 1702, the device can determine the second update (e.g., detailed in connection with reference numeral 1606 of FIG. 16) further in response to an occupancy signal that indicates whether a space proximal to the housing is occupied. In some embodiments, the occupancy signal can indicate or be used to determine a count of occupants, a duration of occupancy, a frequency of occupancy, a time since last occupancy, or another suitable determination.

Hence, at reference numeral 1704, the device can determine the second update further in response to a determination that a count of occupants in the space exceeds a defined threshold. At reference numeral 1706, determining the second update can comprise updating a position of the ultraviolet light device, such as, e.g., targeting areas of occupancy or high occupancy.

### Example Operating Environments

In order to provide additional context for various embodiments described herein, FIG. 18 and the following discussion are intended to provide a brief, general description of a suitable computing environment 1800 in which the various embodiments of the embodiment described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 18, the example environment 1800 for implementing various embodiments of the aspects described herein includes a computer 1802, the computer 1802 including a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors and other multi-processor architectures can also be employed as the processing unit 1804.

The system bus 1808 can be any of several types of bus structure that can further interconnect to a memory bus (with or without a memory controller), a peripheral bus, and a local bus using any of a variety of commercially available bus architectures. The system memory 1806 includes ROM 1810 and RAM 1812. A basic input/output system (BIOS) can be stored in a non-volatile memory such as ROM, erasable programmable read only memory (EPROM), EEPROM, which BIOS contains the basic routines that help to transfer information between elements within the computer 1802, such as during startup. The RAM 1812 can also include a high-speed RAM such as static RAM for caching data.

The computer 1802 further includes an internal hard disk drive (HDD) 1814 (e.g., EIDE, SATA), one or more external storage devices 1816 (e.g., a magnetic floppy disk drive (FDD) 1816, a memory stick or flash drive reader, a memory card reader, etc.) and an optical disk drive 1820 (e.g., which can read or write from a CD-ROM disc, a DVD, a BD, etc.). While the internal HDD 1814 is illustrated as located within the computer 1802, the internal HDD 1814 can also be configured for external use in a suitable chassis (not shown). Additionally, while not shown in environment 1800, a solid state drive (SSD) could be used in addition to, or in place of, an HDD 1814. The HDD 1814, external storage device(s) 1816 and optical disk drive 1820 can be connected to the system bus 1808 by an HDD interface 1824, an external storage interface 1826 and an optical drive interface 1828, respectively. The interface 1824 for external drive implementations can include at least one or both of Universal Serial Bus (USB) and Institute of Electrical and Electronics Engineers (IEEE) 1894 interface technologies. Other external drive connection technologies are within contemplation of the embodiments described herein.

The drives and their associated computer-readable storage media provide nonvolatile storage of data, data structures, computer-executable instructions, and so forth. For the computer 1802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1812, including an operating system 1830, one or more application programs 1832, other program modules 1834 and program data 1836. All or portions of the operating system, applications, modules, and/or data can also be cached in the RAM 1812. The systems and methods described herein can be implemented utilizing various commercially available operating systems or combinations of operating systems.

Computer 1802 can optionally comprise emulation technologies. For example, a hypervisor (not shown) or other intermediary can emulate a hardware environment for operating system 1830, and the emulated hardware can optionally be different from the hardware illustrated in FIG. 18. In such an embodiment, operating system 1830 can comprise one virtual machine (VM) or multiple VMs hosted at computer 1802. Furthermore, operating system 1830 can provide runtime environments, such as the Java runtime environment or the .NET framework, for applications 1832. Runtime environments are consistent execution environments that allow applications 1832 to run on any operating system that includes the runtime environment. Similarly, operating system 1830 can support containers, and applications 1832 can be in the form of containers, which are lightweight, standalone, executable packages of software that include, e.g., code, runtime, system tools, system libraries and settings for an application.

Further, computer 1802 can be enable with a security module, such as a trusted processing module (TPM). For instance with a TPM, boot components hash next in time boot components, and wait for a match of results to secured values, before loading a next boot component. This process can take place at any layer in the code execution stack of computer 1802, e.g., applied at the application execution level or at the operating system (OS) kernel level, thereby enabling security at any level of code execution.

A user can enter commands and information into the computer 1802 through one or more wired/wireless input devices, e.g., a keyboard 1838, a touch screen 1840, and a pointing device, such as a mouse 1842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1804 through an input device interface 1844 that can be coupled to the system bus 1808, but can be connected by other interfaces, such as a parallel port, an IEEE 1394 serial port, a game port, a USB port, an IR interface, a BLUETOOTH® interface, etc.

A monitor 1846 or other type of display device can be also connected to the system bus 1808 via an interface, such as a video adapter 1848. In addition to the monitor 1846, a computer typically includes other peripheral output devices (not shown), such as speakers, printers, etc.

The computer 1802 can operate in a networked environment using logical connections via wired and/or wireless communications to one or more remote computers, such as a remote computer(s) 1850. The remote computer(s) 1850 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1852 is illustrated. The logical connections depicted include wired/wireless connectivity to a local area network (LAN) 1854 and/or larger networks, e.g., a wide area network (WAN) 1856. Such LAN and WAN networking environments are commonplace in offices and companies, and facilitate enterprise-wide computer networks, such as intranets, all of which can connect to a global communications network, e.g., the Internet.

When used in a LAN networking environment, the computer 1802 can be connected to the local network 1854 through a wired and/or wireless communication network interface or adapter 1858. The adapter 1858 can facilitate wired or wireless communication to the LAN 1854, which can also include a wireless access point (AP) disposed thereon for communicating with the adapter 1858 in a wireless mode.

When used in a WAN networking environment, the computer 1802 can include a modem 1860 or can be connected to a communications server on the WAN 1856 via other means for establishing communications over the WAN 1856, such as by way of the Internet. The modem 1860, which can be internal or external and a wired or wireless device, can be connected to the system bus 1808 via the input device interface 1844. In a networked environment, program modules depicted relative to the computer 1802 or portions thereof, can be stored in the remote memory/storage device 1852. It will be appreciated that the network connections shown are example and other means of establishing a communications link between the computers can be used.

When used in either a LAN or WAN networking environment, the computer 1802 can access cloud storage systems or other network-based storage systems in addition to, or in place of, external storage devices 1816 as described above. Generally, a connection between the computer 1802 and a cloud storage system can be established over a LAN 1854 or WAN 1856 e.g., by the adapter 1858 or modem 1860, respectively. Upon connecting the computer 1802 to an associated cloud storage system, the external storage interface 1826 can, with the aid of the adapter 1858 and/or modem 1860, manage storage provided by the cloud storage system as it would other types of external storage. For instance, the external storage interface 1826 can be configured to provide access to cloud storage sources as if those sources were physically connected to the computer 1802.

The computer 1802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### ASPECTS

It is noted that any of aspects 1-20 may be combined with each other in any suitable combination.

Aspect 1. An HVAC device comprising a plurality of individually adjustable directional outlets that, respectively, discharge air into a common space; an ultraviolet light device configured to reduce pathogens in the common space; a processor; and a memory that stores executable instructions that, when executed by the processor, facilitate performance of operations, comprising: updating a state of the plurality of individually adjustable directional outlets in accordance with a first control signal; and updating a state of the ultraviolet light device in accordance with a second control signal.

Aspect 2. The HVAC device in accordance with aspect 1, wherein the ultraviolet light device is coupled to a housing of the plurality of individually adjustable directional outlets.

Aspect 3. The HVAC device in accordance with aspect 1 or 2, wherein the ultraviolet light device is configured for locomotion, and wherein the state of the ultraviolet light device comprises a location of the ultraviolet light device.

Aspect 4. The HVAC device in accordance with any of aspects 1-3, wherein the ultraviolet light device is configured to produce ultraviolet light having a wavelength that is less than or equal to a human-safe threshold that has been determined to be safe for human exposure.

Aspect 5. The HVAC device in accordance with any of aspects 1-4, wherein the human-safe threshold is 222 nanometers.

Aspect 6. The HVAC device in accordance with any of aspects 1-5, wherein the ultraviolet light device is configured to expose a portion of the common space to ultraviolet light for a duration that is greater than or equal to a pathogen killing time.

Aspect 7. The HVAC device in accordance with any of aspects 1-6, wherein the pathogen killing time is about 0.2 seconds.

Aspect 8. The HVAC device in accordance with any of aspects 1-7, further comprising an occupancy sensor that transmits an occupancy signal in response to sensing an occupant in the common space.

Aspect 9. The HVAC device in accordance with any of aspects 1-8, wherein at least one of the first control signal and the second control signal is determined based on the occupancy signal.

Aspect 10. The HVAC device in accordance with any of aspects 1-9, wherein at least one of the first control signal and the second control signal is determined based on a control signal received from a control device.

Aspect 11. The HVAC device in accordance with any of aspects 1-10, wherein the control device that transmits the control signal is at least one of a group comprising: a thermostat that is configured to control a first associated one of the plurality of individually adjustable directional outlets, a user device that is configured to control a second associated one of the plurality of individually adjustable directional outlets, and a master control device that is configured to control the plurality of individually adjustable directional outlets.

Aspect 12. The HVAC device in accordance with any of aspects 1-11, wherein the ultraviolet light device is situated within an interior space of the HVAC device and situated proximal to a catalyst structure that is configured to facilitate production of dry hydrogen peroxide molecules in response to exposure to ultraviolet light and ambient air.

Aspect 13. The HVAC device in accordance with any of aspects 1-12, wherein the ultraviolet light device is situated within an interior space of the HVAC device and situated proximal to a catalyst structure that is configured to facilitate photo catalytic oxidation comprising production of hydroxyl radicals in response to exposure to ultraviolet light and ambient air.

Aspect 14. A master control device, comprising: a processor; and a memory that stores executable instructions that, when executed by the processor, facilitate performance of operations, comprising: receiving a signal from at least one of a control device or a sensor device; based on the signal, determining an update to a state of a plurality of individually adjustable directional outlets that, respectively, discharge air into a common space; and based on the signal, determining an update to a state of an ultraviolet light device.

Aspect 15. The master control device in accordance with aspects 14, wherein the ultraviolet light device is coupled to a housing of the plurality of individually adjustable directional outlets.

Aspect 16. The master control device in accordance with any of aspects 14-15, wherein the ultraviolet light device is configured for locomotion, and wherein the state of the ultraviolet light device comprises a location or an orientation of the ultraviolet light device.

Aspect 17. A method, comprising: receiving, by a device comprising a processor, a signal from at least one of a control device or a sensor device; based on the signal, determining, by the device, a first update to a state for a plurality of individually adjustable directional outlets that, respectively, discharge air into a common space; and determining, by the device, a second update to a state of an ultraviolet light device that is coupled to a housing of the plurality of individually adjustable directional outlets, wherein the second update is a function of the state of the plurality of individually adjustable directional outlets.

Aspect 18. The method in accordance with aspect 17, wherein the determining the second update is further in response to an occupancy signal that indicates whether a space proximal to the housing is occupied.

Aspect 19. The method in accordance with any of aspects 17-18, wherein the determining the second update is further in response to a determination that a count of occupants in the space exceeds a defined threshold.

Aspect 20. The method in accordance with any of aspects 17-19, wherein the determining the second update comprises updating a position or orientation of the ultraviolet light device.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in any appropriately detailed structure.

What is claimed is:

1-20. (canceled)

21. A heating, ventilation, and air conditioning (HVAC) device, comprising: a housing comprising a common plenum;
a plurality of individually-adjustable directional outlets, wherein
each individually-adjustable directional outlet of the plurality of individually-adjustable directional outlets is coupled to the housing to receive air from the common plenum and to discharge a corresponding portion of the air as a personalized air flow of a plurality of personalized air flows such that each personalized air flow of the plurality of personalized air flows is directed to a corresponding individualized portion of a plurality of individualized portions of a common space; and
one or more air quality elements, wherein
the one or more air quality elements are coupled to the housing and are situated with respect to the plurality of individually-adjustable directional outlets such that an amount of exposure of a respective one of the plurality of personalized air flows to the one or more air quality elements is based, at least in part, on a volume of air flow of the respective one of the plurality of personalized air flows, and
the volume of air flow of the respective one of the plurality of personalized air flows is regulated by a corresponding one of the plurality of individually-adjustable directional outlets that discharges the respective one of the plurality of personalized air flows.

22. The HVAC device of claim 21, wherein
the one or more air quality elements comprise a plurality of filters, and
each of the plurality of filters is situated with respect to each of the plurality of individually-adjustable directional outlets by virtue of being located to filter the personalized air flow of a plurality of personalized air flows corresponding to the each of the plurality of individually-adjustable directional outlets.

23. The HVAC device of claim 21, wherein
the one or more air quality elements comprise a dry hydrogen peroxide device, and
the dry hydrogen peroxide device is situated with respect to each of the plurality of individually-adjustable directional outlets by virtue of being configured to expose the personalized air flow of a plurality of personalized air flows corresponding to the each of the plurality of individually-adjustable directional outlets by adjusting a location of the dry hydrogen peroxide device with respect to the personalized air flow or by causing the each of the plurality of individually-adjustable directional outlets to adjust the volume of air flow of the personalized air flow of a plurality of personalized air flows corresponding to the each of the plurality of individually-adjustable directional outlets.

24. The HVAC device of claim 21, wherein
the one or more air quality elements comprise a photocatalytic oxidation device, and
the photocatalytic oxidation device is situated with respect to each of the plurality of individually-adjustable directional outlets by virtue of being configured to expose the personalized air flow of a plurality of personalized air flows corresponding to the each of the plurality of individually-adjustable directional outlets by adjusting a location of the photocatalytic oxidation device with respect to the personalized air flow or by causing the each of the plurality of individually-adjustable directional outlets to adjust the volume of air flow of the personalized air flow of a plurality of personalized air flows corresponding to the each of the plurality of individually-adjustable directional outlets.

25. The HVAC device of claim 21, wherein
the one or more air quality elements comprise an ultraviolet light device, and
the ultraviolet light device is situated with respect to each of the plurality of individually-adjustable directional outlets by virtue of being configured to expose the personalized air flow of a plurality of personalized air flows corresponding to the each of the plurality of individually-adjustable directional outlets by adjusting a location of the ultraviolet light device with respect to the personalized air flow, an intensity of ultraviolet light produced by the ultraviolet light device with respect to the personalized air flow, a duration of the ultraviolet light produced by the ultraviolet light with respect to the personalized air flow, a frequency of on/off pulses of the ultraviolet light produced by the ultraviolet light with respect to the personalized air flow, an intensity of the ultraviolet light produced by the ultraviolet light with respect to the personalized air flow, or a wavelength of the ultraviolet light produced by the ultraviolet light with respect to the personalized air flow.

26. The HVAC device of claim 25, further comprising:
a processor; and
a computer-readable storage medium that stores executable instructions that, when
executed by the processor, facilitate performance of operations comprising
updating a state of the plurality of individually-adjustable directional outlets in accordance with a first control signal; and
updating a state of the ultraviolet light device in accordance with a second control signal, wherein
the ultraviolet light device is configured to expose at least a portion of the air to ultraviolet light produced by the ultraviolet light device, and
the first control signal is updated such that at least one of the plurality of personalized air flows is exposed to the ultraviolet light for a duration that is greater than or equal to a pathogen killing time.

27. The HVAC device of claim 26, wherein
the ultraviolet light device is situated externally to the housing and is configured for locomotion,
the state of the ultraviolet light device comprises the location of the ultraviolet light device, and
the location of the ultraviolet light device comprises a position of the ultraviolet light device and an orientation of the ultraviolet light device.

28. The HVAC device of claim 26, wherein
the processor is configured to receive a control signal from a control device,
the control device that transmits the control signal is at least one of a group comprising: a thermostat that is configured to control a first associated one of the plurality of individually-adjustable directional outlets, a user device that is configured to control a second associated one of the plurality of individually-adjustable directional outlets, and a master control device that is configured to control the plurality of individually-adjustable directional outlets.

29. The HVAC device of claim 26, further comprising:
an occupancy sensor, wherein
the occupancy sensor is configured to avoid exposure of an occupant of an individualized portion of the plurality of individualized portions of the common space to the ultraviolet light produced by the ultraviolet light device by
sensing whether the individualized portion of the plurality of individualized portions of the common space is occupied by the occupant, and
in response to the occupancy sensor sensing that the individualized portion is occupied by an occupant, transmitting an occupancy signal to the processor, and
at least one of the first control signal and the second control signal is determined based on the occupancy signal.

30. The HVAC device of claim 25, wherein
the one or more air quality elements further comprise a catalyst structure,
the ultraviolet light device is situated proximal to the catalyst structure, and
the catalyst structure is configured to
facilitate production of dry hydrogen peroxide molecules, in response to exposure to the ultraviolet light and the air, or
facilitate photocatalytic oxidation comprising production of hydroxyl radicals, in response to exposure to the ultraviolet light and the air.

31. The HVAC device of claim 21, further comprising:
a processor; and
a computer-readable storage medium that stores executable instructions that, when
executed by the processor, facilitate performance of operations comprising
receiving an air quality signal from an air quality sensor, wherein
the air quality signal represents an air quality metric for one or more of the plurality of personalized air flows, and
responsive to the air quality signal, maintaining an air quality metric by controlling at least one of the one or more air quality elements and/or one or more of the plurality of individually-adjustable directional outlets, wherein
the controlling comprises
adjusting the at least one of the one or more air quality elements, and
regulating a corresponding personalized air flow of the plurality of personalized air flows corresponding to each of the one or more of the plurality of individually-adjustable directional outlets, and
the controlling maintains the air quality metric for each corresponding personalized air flow of the plurality of personalized air flows.

32. The HVAC device of claim 31, wherein the operations further comprise:
calculating an air quality index for the each corresponding personalized air flow of the plurality of personalized air flows;
comparing the air quality index for the each corresponding personalized air flow of the plurality of personalized air flows to an indoor air quality standard; and
in response to the air quality index for the each corresponding personalized air flow of the plurality of personalized air flows not meeting the indoor air quality standard, further controlling the at least one of the one or more air quality elements and/or the one or more of the plurality of individually-adjustable directional outlets to meet the indoor air quality standard.

33. The HVAC device of claim 32, wherein
the air quality index for the each corresponding personalized air flow of the plurality of personalized air flows comprises one or more air quality parameters,
the one or more air quality parameters is an infective organism parameter, and
an amount of disinfection of the each corresponding personalized air flow of the plurality of personalized air flows is proportional to the adjusting.

34. The HVAC device of claim 31, wherein
the air quality metric for the each corresponding personalized air flow of the plurality of personalized air flows is maintained by virtue of the each corresponding personalized air flow of the plurality of personalized air flows being exposed to the one or more air quality elements in an amount proportional to the volume of air flow of the each corresponding personalized air flow of the plurality of personalized air flows.

35. The HVAC device of claim 31, wherein
the housing further comprises an inlet, and
the common plenum comprises an inlet plenum at the inlet, wherein
the inlet is configured to receive air from a common space in which the HVAC device is situated, and
the HVAC device is configured to be situated in the common space such that each of the plurality of personalized air flows is directed to a corresponding individualized portion of a plurality of individualized portions of the common space.

36. A heating, ventilation, and air conditioning (HVAC) controller comprising:
a processor; and
a computer-readable storage medium that stores executable instructions that, when
executed by the processor, facilitate performance of operations comprising
controlling one or more of a plurality of individually-adjustable directional outlets of an air quality device, wherein
the air quality device comprises a housing comprising a common plenum, a plurality of individually-adjustable directional outlets, and one or more air quality elements,
each individually-adjustable directional outlet of the plurality of individually-adjustable directional outlets is coupled to the housing to receive air from the common plenum and to discharge a corresponding portion of the air as a personalized air flow of a plurality of personalized air flows such that each personalized air flow of the plurality of personalized air flows is directed to a corresponding individualized portion of a plurality of
individualized portions of a common space, the controlling the one or more of the plurality of individually-adjustable directional outlets of the air quality device comprises regulating a volume of air flow of a respective one of the plurality of personalized air flows by controlling a corresponding one of the plurality of individually-adjustable directional outlets that discharges the respective one of the plurality of personalized air flows,
controlling at least one of one or more air quality elements of the air quality device, wherein
the one or more air quality elements are coupled to the housing and are situated with respect to the plurality of individually-adjustable directional outlets, and
the at least one of one or more air quality elements are controlled such that an amount of exposure of the respective one of the plurality of personalized air flows to the one or more air quality elements is based, at least in part, on the volume of air flow of the respective one of the plurality of personalized air flows.

37. The HVAC controller of claim 36, wherein the operations further comprise:
updating a state of the plurality of individually-adjustable directional outlets in accordance with a first control signal, wherein
the one or more air quality elements comprise an ultraviolet light device controlled by the HVAC controller; and
updating a state of the ultraviolet light device in accordance with a second control signal, wherein
the ultraviolet light device is configured to expose at least a portion of the air discharged into the common space to ultraviolet light produced by the ultraviolet light device, and
the first control signal is updated such that an air flow of the at least the portion of the air is exposed to the ultraviolet light for a duration that is greater than or equal to a pathogen killing time.

38. The HVAC controller of claim 37, wherein the operations further comprise:
the one or more air quality elements further comprise a catalyst structure,
the ultraviolet light device is situated proximal to the catalyst structure, and
the catalyst structure is configured to
facilitate production of dry hydrogen peroxide molecules, in response to exposure to the ultraviolet light and the air, or
facilitate photocatalytic oxidation comprising production of hydroxyl radicals, in response to exposure to the ultraviolet light and the air.

39. The HVAC controller of claim 36, wherein the operations further comprise:
receiving an air quality signal from an air quality sensor, wherein
the air quality signal represents an air quality metric for one or more of the plurality of personalized air flows, and
responsive to the air quality signal, maintaining an air quality metric by performing the controlling the at least one of the one or more air quality elements and/or the one or more of the plurality of individually-adjustable directional outlets, wherein
the controlling comprises
adjusting the at least one of the one or more air quality elements, and
regulating a corresponding personalized air flow of the plurality of personalized air flows corresponding to each of the one or more of the plurality of individually-adjustable directional outlets and controls, and
the controlling maintains the air quality metric for each corresponding personalized air flow of the plurality of personalized air flows.

40. The HVAC controller of claim 39, wherein the operations further comprise:
calculating an air quality index for the each corresponding personalized air flow of the plurality of personalized air flows;
comparing the air quality index for the each corresponding personalized air flow of the plurality of personalized air flows to an indoor air quality standard; and
in response to the air quality index for the each corresponding personalized air flow of the plurality of personalized air flows not meeting the indoor air quality standard, further controlling the at least one of the one or more air quality elements and/or the one or more of the plurality of individually-adjustable directional outlets to meet the indoor air quality standard.
